(19) United States
(12) Patent Application Publication
(10) Pub. No.: US 2018/0341971 A1
(43) Pub. Date: Nov. 29, 2018

(54) LOYALTY ACCOUNT MANAGEMENT SYSTEM AND METHOD

(71) Applicant: MASTERCARD INTERNATIONAL INCORPORATED, PURCHASE, NY (US)

(72) Inventors: Hemal Shah, Baroda (IN); Arpit Patel, Vadodara (IN); Gaurav Dayal, Vadodara (IN)

(21) Appl. No.: 15/989,573

(22) Filed: May 25, 2018

(30) Foreign Application Priority Data
May 29, 2017 (SG) 10201704372T

(51) Int. Cl. G06Q 30/02

(52) U.S. Cl. CPC G06Q 30/0227; G06Q 30/0233

(57) ABSTRACT

A system for managing multiple loyalty accounts, the system including one or more processing devices that receive a request indicative of a merchant and a user identifier, use the user identifier to obtain loyalty point data indicative of at least a points balance for each of multiple user loyalty accounts, use the merchant identifier to determine a merchant loyalty program for which the merchant can redeem loyalty points, calculate a points amount with the loyalty point data, the merchant loyalty program, and one or more rules, the one or more rules being at least partially indicative of conversion rates between loyalty programs, and at least one of provide a points indication indicative of the points amount to allow the points amount to be presented to the user, and cause points to be redeemed at least partially to allow a transaction to be selectively performed.

### CROSS REFERENCE TO RELATED APPLICATIONS

This patent application claims priority to Singapore Application No. 10201704372T filed on May 29, 2017, the disclosure of which is incorporated by reference herein in its entirety as part of the present application.

### BACKGROUND

The present disclosure relates to a system and method for managing multiple loyalty accounts, and in particular multiple loyalty accounts associated with a number of different loyalty programs.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavor to which this specification relates.

Loyalty programs, also referred to as reward programs, operate by rewarding customers for repeat business. Typically the customer is issued with an account, optionally having an associated card, with points being allocated to the account when the user performs a transaction. The points can then be redeemed, for example by exchanging the points for credit or particular goods or services. Typically loyalty program are operated by individual merchants, or a group of merchants acting in conjunction. As a result, customers are often members of multiple different loyalty programs, with different merchants or groups of merchants. This leads to a number of difficulties.

For example, it is difficult for user's to track individual programs, and are often unaware of how many points they have available to be redeemed. The opportunity to redeem points is often limited, with user's only being able to redeem points when shopping with a particular user, meaning many points expire or otherwise remain unused. Consequently, loyalty programs are often of only limited benefit to customers, meaning many customers choose to not participate in the programs.

### BRIEF DESCRIPTION

In one aspect, a system for managing multiple loyalty accounts is provided. The system includes one or more processing devices that receive a request indicative of a merchant identifier, and a user identifier, use the user identifier to obtain loyalty point data indicative of at least a points balance for each of multiple user loyalty accounts, the multiple user loyalty accounts being associated with a number of different loyalty programs, use the merchant identifier to determine a merchant loyalty program, the merchant loyalty program being a loyalty program for which the merchant can redeem loyalty points, calculate a points amount in accordance with the loyalty point data, the merchant loyalty program, one or more rules, the one or more rules being at least partially indicative of conversion rates between loyalty programs, and at least one of provide a points indication indicative of the points amount to thereby allow the points amount to be presented to the user, and cause points to be redeemed at least partially in accordance with the points amount to thereby allow a transaction to be selectively performed.

In one embodiment the request is a balance request and the points amount is indicative of a total available points balance.

In one embodiment the request is a transaction request indicative of a transaction amount and the one or more processing devices calculate the points amount at least in part using the transaction amount, the points amount being indicative a number of points required to complete a transaction for the transaction amount.

In one embodiment the request is a redemption request indicative of a redemption amount and the one or more processing devices calculate the points amount at least in part using the redemption amount, the points amount being indicative a number of points to be redeemed.

In one embodiment the points amount is indicative of a points breakdown defining a number of loyalty points for each of a number of user loyalty accounts.

In one embodiment the loyalty point data is indicative of at least one of a user assigned preference, a loyalty point expiry date, and a loyalty account usage.

In one embodiment the rules are defined so that the one or more processing devices calculate the points amount so as to optimize a monetary benefit for the user.

In one embodiment the rules are defined so that the one or more processing devices calculate the points amount taking into account a relative loyalty point expiry date for loyalty points of the user loyalty accounts, a loyalty account usage, and a user assigned preference.

In one embodiment the one or more processing devices use the user identifier to access a user profile and determine, using the user profile, at least one of the loyalty point data and rules.

In one embodiment the user profile includes a current points balance for each of a number of user loyalty accounts, and wherein the one or more processing devices updates the current points balance at least one of periodically, and in response to a loyalty account points balance notification from a loyalty provider processing system.

In one embodiment the one or more processing devices identify one or more user loyalty accounts from the user profile query a loyalty provider processing system of each of the user loyalty accounts to determine a current points balance of each user loyalty account, and determine the point data using the current points balance.

In one embodiment the one or more processing devices causes loyalty points for a respective user loyalty account to be redeemed by generating a redemption instruction indicative of a redemption amount and a recipient, providing the redemption instruction to a loyalty provider processing system that manages the user loyalty account, the loyalty provider processing system being responsive to the redemption instruction to redeem the points in accordance with the redemption amount and the recipient.

In one embodiment the system includes a transaction system, a payment system, and a loyalty account management system including the one or more processing devices.

In one embodiment the loyalty account management system calculates the points amount and provides the points amount to the transaction system via the payment system, allowing the points amount to be displayed to at least one of a user and a merchant.

In one embodiment the loyalty account management system calculates a points amount and provides the points indication to the payment system, and the payment system generates a points message indicative of the points amount, provides the points message to the transaction system, and the transaction system receives the points message, and displays an indication of the points amount.

In one embodiment, in response to user interaction with the merchant, the transaction system generates an interaction message indicative of at least the merchant identifier and the user identifier, provides the interaction message to the payment system, the payment system being responsive to the interaction message to provide the request indication to the loyalty account management system.

In one embodiment the user interaction is a transaction request and wherein the interaction message is a transaction request message indicative of a transaction amount, and the request indication is a transaction request indication indicative of the transaction amount.

In one embodiment the user interaction is a transaction conformation, the interaction message is a transaction confirmation message indicative of a redemption amount, and the request indication is a redemption request indication indicative of the transaction amount.

In one embodiment the transaction confirmation message is indicative of a required funds amount and wherein the payment system is responsive to the transaction confirmation message to cause a payment to be performed in accordance with the required funds amount.

In one embodiment the transaction system displays an indication of the points amount, determines a redemption amount in accordance with user input commands, and causes the transaction to be performed in accordance with the redemption amount.

In one embodiment the transaction device is at least one of a transaction terminal, an ATM, a POS terminal, a merchant server hosting a website of the merchant, and a client device.

In one embodiment the payment system includes at least one of at least one acquirer processing device, at least one issuer processing device, and at least one payment network processing device in communication with the loyalty account management system.

In one embodiment: the merchant identifier is indicative of at least one of a merchant identity and a merchant account of the merchant, and the user identifier is indicative of at least one of a user identity, a user account of the user, and a user profile of the user.

In another aspect, a method for managing multiple loyalty account is provided. The method includes in one or more processing devices receiving a request indicative of a merchant identifier and a user identifier, using the user identifier to obtain loyalty point data indicative of at least a points balance for each of multiple user loyalty accounts, the multiple user loyalty accounts being associated with a number of different loyalty programs, using the merchant identifier to determine a merchant loyalty program, the merchant loyalty program being a loyalty program for which the merchant can redeem loyalty points, calculating a points amount in accordance with the loyalty point data, the merchant loyalty program, and one or more rules, the one or more rules being at least partially indicative of conversion rates between loyalty programs, and at least one of providing a points indication indicative of the points amount to thereby allow the points amount to be presented to the user enabling the user to selectively perform a transaction at least partially in accordance with the points amount, and causing points to be redeemed at least partially in accordance with the points amount to thereby allow a transaction to be selectively performed.

In another aspect, a system for managing multiple loyalty account is provided. The system includes a transaction system that generates an interaction message indicative of the merchant identifier and the user identifier, and provides the interaction message to a payment system, the payment system being responsive to the interaction message to cause a loyalty account management system to use the user identifier to obtain loyalty point data indicative of at least a points balance for each of multiple user loyalty accounts, the multiple user loyalty accounts being associated with a number of different loyalty programs, use the merchant identifier to determine a merchant loyalty program, the merchant loyalty program being a loyalty program for which the merchant can redeem loyalty points, calculate a points amount in accordance with the loyalty point data, the merchant loyalty program, and one or more rules, the one or more rules being at least partially indicative of conversion rates between loyalty programs, receives a points message indicative of the points amount from the payment system, and displays an indication of the points amount.

In another aspect, a method for managing multiple loyalty account is provided. The method includes, in a transaction system, generating an interaction message indicative of the merchant identifier and the user identifier, and providing the interaction message to a payment system, the payment system being responsive to the interaction message to cause a loyalty account management system to use the user identifier to obtain loyalty point data indicative of at least a points balance for each of multiple user loyalty accounts, the multiple user loyalty accounts being associated with a number of different loyalty programs, use the merchant identifier to determine a merchant loyalty program, the merchant loyalty program being a loyalty program for which the merchant can redeem loyalty points, calculate a points amount in accordance with the loyalty point data, the merchant loyalty program, and one or more rules, the one or more rules being at least partially indicative of conversion rates between loyalty programs, receiving a points message indicative of the points amount from the payment system, and displaying an indication of the points amount.

In another aspect, a system for managing multiple loyalty account is provided. The system includes a transaction system, a payment system, and a loyalty account management system, wherein, in use the transaction system generates an interaction message indicative of the merchant identifier and the user identifier, and provides the interaction message to a payment system, the payment system receives the interaction message, generates a request using the interaction message, the request being indicative of the merchant identifier, and the user identifier, and provides the request to the loyalty account management system, and the loyalty account management system receives the request, uses the user identifier to obtain loyalty point data indicative of at least a points balance for each of multiple user loyalty accounts, the multiple user loyalty accounts being associated with a number of different loyalty programs, uses the merchant identifier to determine a merchant loyalty program, the merchant loyalty program being a loyalty program for which the merchant can redeem loyalty points, calculates a points amount in accordance with the loyalty point data, the merchant loyalty program, and one or more rules, the one or more rules being at least partially indicative of conversion rates between loyalty programs, and at least one of provides a points indication indicative of the points amount to thereby allow the points amount to be presented to the user enabling the user to selectively perform a transaction at least partially in accordance with the points amount, and causes points to be redeemed at least partially in accordance with the points amount to thereby allow a transaction to be selectively performed.

In another aspect, a method for managing multiple loyalty account is provided. The method includes, in a transaction system, generating an interaction message indicative of the merchant identifier and the user identifier, and providing the interaction message to a payment system, in a payment system, receiving the interaction message, generating a request using the interaction message, the request being indicative of the merchant identifier and the user identifier, and providing the request to the loyalty account management system, and in a loyalty account management system, receiving the request, using the user identifier to obtain loyalty point data indicative of at least a points balance for each of multiple user loyalty accounts, the multiple user loyalty accounts being associated with a number of different loyalty programs, using the merchant identifier to determine a merchant loyalty program, the merchant loyalty program being a loyalty program for which the merchant can redeem loyalty points, calculating a points amount in accordance with the loyalty point data, the merchant loyalty program, and one or more rules, the one or more rules being at least partially indicative of conversion rates between loyalty programs, and at least one of providing a points indication indicative of the points amount to thereby allow the points amount to be presented to the user enabling the user to selectively perform a transaction at least partially in accordance with the points amount, and causing points to be redeemed at least partially in accordance with the points amount to thereby allow a transaction to be selectively performed.

It will be appreciated that the embodiments of the disclosure and their respective features can be used in conjunction, interchangeably and/or independently, and reference to separate embodiments is not intended to be limiting.

### BRIEF DESCRIPTION OF THE DRAWINGS

An example of the present disclosure will now be described with reference to the accompanying drawings, in which:

FIG. 1 is a flow chart of an example of a process for managing multiple loyalty programs;

FIG. 2 is a schematic diagram of a distributed network architecture;

FIG. 3 is a schematic diagram of an example of a processing system of FIG. 2;

FIG. 4 is a schematic diagram of an example of a transaction system of FIG. 2;

FIG. 5 is a schematic diagram of an example of a client device of FIG. 2;

FIG. 6 is a flow chart of an example of process for creating a user profile;

FIGS. 7A-7C are flow charts of an example of a process for performing a transaction using multiple loyalty programs; and

FIG. 8 is a flow chart of an example of the process for redeeming points for performing a transaction.

### DETAILED DESCRIPTION

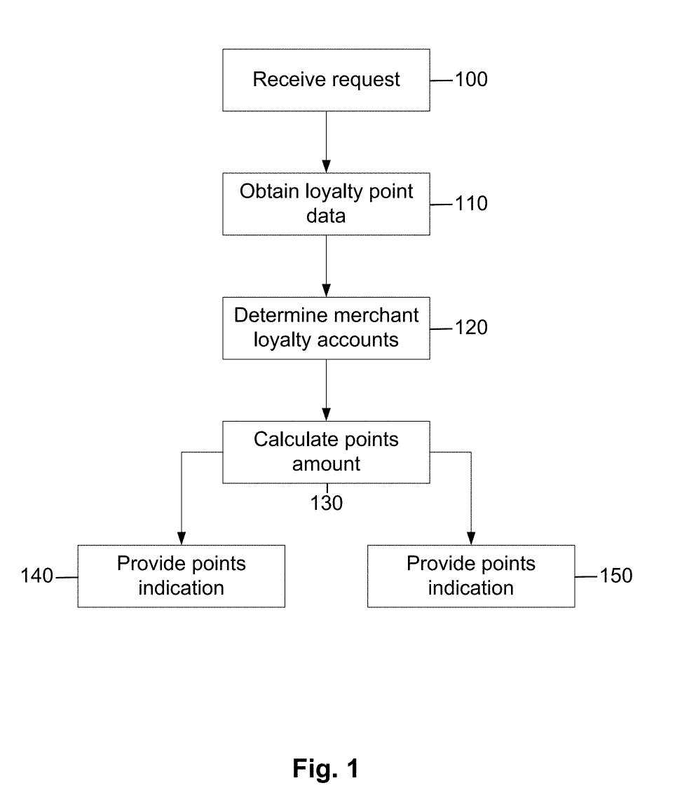

An example of a process for use in managing loyalty accounts will now be described with reference to FIG. 1.

For the purpose of this example, it is assumed that the process is performed at least in part utilizing one or more processing devices. The one or more processing devices can form part of one or more processing systems, such as one or more servers, computer systems or the like and may form part of a payment network backend, or similar. Whilst reference may be made generally to a single processing device in the remainder the description, this is for the purpose of ease of explanation only and it will be appreciated that in practice functionality could be distributed across multiple processing devices, for example forming part of different processing systems, and the term should not therefore be considered as limiting.

For the purpose of ease of illustration, the term “loyalty program” will be used to refer to a program or scheme in which points are allocated to a customer in return for business, and which can be redeemed in return for a benefit of some form, such as credit for future transactions, discounted goods or services, or the like. It will be understand that the “loyalty program” is intended to be used interchangeably with “reward program” or “reward scheme” and these are not intended to have different meanings. For ease of illustration, the term “loyalty account” will be understood to refer to a user account associated with a respective loyalty program. The term “loyalty provider” is used to refer to an entity that is running a “loyalty program”, optionally on behalf of one or more merchants, whilst the term “management provider” will be used to refer to an entity that is providing a management service to manage multiple loyalty programs.

In this example, at step 100, the processing device receives a request indicative of a merchant identifier and a user identifier. The request could be received in any suitable manner, and could be received directly from a transaction system, such as a transaction terminal or server associated with a merchant website, or could be received from an intervening payment processing system, such as an acquirer switch, payment network gateway, or the like. The request can be generated in response to user interaction with the merchant, or following a user requesting or confirming a transaction, and could be generated as part of a transaction process, for example following creation of a transactions pre-authorization from a merchant terminal, as will be described in more detail below.

The identifiers are typically at least partially indicative of an identity of the merchant and the user and may be in any suitable form. For example, the identifiers could be in the form of account identifiers associated with accounts of the merchant or user respectively, or may include information directly indicative of an identity of the merchant or user, such as a name, identification number or the like.

At step 110, the processing device uses the user identifier to obtain loyalty point data indicative of at least a points balance associated with multiple user loyalty accounts of the user. The multiple user loyalty accounts are associated with a number of different loyalty programs, and may include a user account for each loyalty program, although this is not essential and in some examples, a user may have multiple accounts for a given loyalty program, for example having a personal and work or family account, or the like.

The manner in which loyalty point data is obtained will vary depending upon the preferred implementation, but could involve retrieving a user profile based on the user identifier, and then obtaining the point balance from the user profile. Alternatively, this may involve obtaining a points balance from one or more loyalty providers that operate loyalty programs associated with the multiple user loyalty accounts.

At step 120, the processing device uses the merchant identifier to determine a merchant loyalty program. In particular, the merchant loyalty program is a program for which the merchant is able to redeem points, and could include for example a loyalty program of the merchant, or loyalty program of one or more partnering organizations, or the like. The indication of the merchant program is typically stored in a database and retrieved based on the merchant identifier, but alternatively may be obtained by querying the merchant or retrieving the information from a loyalty provider.

At step 130, the processing device calculates a points amount. The points amount is typically calculated in accordance with the loyalty point data, the merchant loyalty program, and one or more rules. In this regard, the rules are used to define how points can be converted between different loyalty programs allowing the processing device to calculate the number of loyalty points that can be redeemed for the particular merchant. In one example, the rules are therefore indicative of conversion rates between loyalty programs, but could additionally and/or alternatively take into account other factors, such as restrictions on conversions between loyalty programs, or the like.

The points amount can be used either to provide a points indication indicative of the points amount to thereby allow the points amount to be presented to the user at step 140 and/or cause points to be redeemed at least partially in accordance with the points amount to thereby allow a transaction to be selectively performed at step 150.

Accordingly, the above described process operates to consolidate loyalty points from multiple loyalty accounts in one or more loyalty programs into a single points amount that can be redeemed with the respective merchant. By using appropriate rules, this automatically takes into account the ability to convert points between different loyalty programs, so for example, if a merchant is willing to redeem points from loyalty program A and loyalty program B can be converted to loyalty program A points using a factor of 0.5, then if the user has 1000 points with loyalty program A and 1000 points with loyalty program B, this provides 1500 points the user can redeem with the merchant.

It will be appreciated that this therefore allows a user to not only readily understand what points can be used when performing a transaction with the merchant, but additionally, allows the user to more effectively utilize points across multiple different loyalty programs, reducing the likelihood of points remaining unused, and encouraging further uptake of loyalty programs.

A number of further features will now be described.

In one example, the points amount provided to the user can simply be indicative of a total number of points available. This may be presented if the request is a general request, such as a balance request, or is a requested provided when the user simply browsing a website of the merchant.

Alternatively, if the request relates to a transaction request, for example in the event that the user wishes to perform a specific transaction with the merchant, then the transaction request can be indicative of a transaction amount. In this instance, the points amount can be calculated using the transaction amount so that the points amount is indicative of a number of points required to complete a transaction.

Similarly, if the user has confirmed they wish to proceed with the transaction by redeeming at least some points, the request can be a redemption request indicative of a redemption amount and the one or more processing devices calculate the points amount at least in part using the redemption amount so that the points amount being indicative a number of points to be redeemed.

In all of the above cases, the points amount can be a simple total, thereby indicating the total amount of points available, or that will be redeemed for the given transaction and/or redemption amount. However, in order to assist the user correctly understand what points are being used, and to ensure points are redeemed correctly, more typically the points amount is indicative of a redemption breakdown defining a number of loyalty points for each of a number of user loyalty accounts. Thus, the user can see how many points are being used from each of their user accounts, while the redemption can be performed in accordance with the breakdown, to ensure points are redeemed correctly across the user loyalty accounts. It will be appreciated that the points amount, including the breakdown can be calculated in accordance with the rules.

Whilst calculation of the points amount can simply based on number of available points, additionally, and/or alternatively, the loyalty point data can be indicative of one or more factors such as a user assigned preference, a loyalty point expiry date or a loyalty account usage, with this being taken into account when calculating the points amount. In particular, this can be used to allow the processing device to preferentially assign which loyalty points are used, for example ensuring points shortly due to expire are used in preference to other points.

Thus, for example, if the number of points required to perform a transaction is 2000 points and the user has 1000 points available in each of four different loyalty programs, the processing device can select two of the loyalty programs based on points which are to expire first, or a user assigned preference. Typically the rules are configured to ensure that points are utilized so that no points ever reach their expiry date and in accordance with a user assigned preference. Failing the preference on that basis, the selection can be made taking conversion rates into account, to minimize conversion losses.

Accordingly, through appropriate configuration of the rules, this can be used to ensure points are preferentially utilized in the user's favor and specifically to optimize a monetary benefit for the user. The rules can be standard rules for the entire system and/or could include user defined rules, allowing users to control how their points from their loyalty accounts are utilized.

In one example the processing device uses the user identifier to access a user profile, determining the loyalty point data and optionally rules at least in part from the user profile. In one example, this is achieved by having a loyalty program points balance for each of a number of loyalty programs stored as part of the user profile. In this case, the points balance could be updated periodically, for example by having the processing device request updated information from a loyalty provider processing system on a periodic basis, or in response to a loyalty program points balance notification being provided from a loyalty provider processing system, allowing points balances to be pushed to the processing device as required.

Alternatively, the processing device can identify one or more loyalty programs from the user profile and query a loyalty provider processing system for each of the one or more loyalty programs to thereby determine a current loyalty program points balance. Thus, in this example, a current points balance is only retrieved as needed.

The processing device is also typically adapted to control the redemption process so that when a transaction is performed, points can automatically be redeemed from various ones of the user loyalty accounts as required. In order to achieve this, the processing device typically receives an indication of a redemption amount, as described above, calculating a breakdown indicative of the loyalty points to be redeemed for each of a number of user loyalty accounts using this information and the rules. Thus, the user can simply nominate the number of points to be used with the transaction then being performed automatically on the basis of that number of points, taking into account a breakdown that will maximize the monetary benefit for the user.

In one example, the processing device causes loyalty points for a respective user account to be redeemed by generating a redemption instruction indicative of a point redemption amount and a recipient, providing the redemption instruction to a loyalty provider processing system that manages the loyalty program, with the loyalty provider processing system being responsive to the instruction to thereby redeem the points.

In the above example, the processing device can form part of an overall transaction system. In this example, the system typically includes a transaction system, a payment processing system, such as a payment network back end and a loyalty account management system, which includes the one or more processing devices. In one example, the transaction system includes any form of system that can facilitate a transaction between a user and a merchant, but in one example is a system such as a transaction terminal, an ATM (Automated Teller Machine), a POS (Point of Sales) terminal or a merchant server hosting a website of the merchant. Alternatively, this could include a client device of the user, depending on the manner in which the transaction is being performed.

Similarly, the payment system is typically a system adapted to facilitate a payment between the user and the merchant, and can include at least one acquirer processing device, typically associated with an acquirer that administers an account of the merchant and at least one issuer processing device associated with an issuer that administers an account of the user. The payment system also typically includes at least one payment network processing device, for example forming part of a payment network service, with the payment network processing device optionally may be in communication with the loyalty account management system.

In this example, communication from the loyalty provider processing system can be via the payment processing system. In this instance when the loyalty account management system calculates a point amount it provides a points indication to the payment system which then generates a points message and provides the points message to the transaction system allowing the transaction to receive the points message and display an indication of the points amount. It will be appreciated that in this instance, the points message can be the same as the points indication, with this simply being forwarded by the payment system, although more typically the payment system will typically be required to generate the points message in a predetermined messaging format suitable for transmission to the transaction system, depending on transaction system requirements.

Similarly, in response to user interaction with the merchant, the transaction system typically generates an interaction message indicative of the merchant and user identifiers, providing the interaction message to the payment processing system with the payment processing system then providing a request indication to the loyalty provider processing system, which is again indicative of the merchant and user identifiers. Again, the message and request can be the same, but more typically are converted depending on messaging requirements of the transaction system and the loyalty account management system.

It will be appreciated from the above that the transaction system typically provides messages to the payment processing system with the payment processing system then forwarding relevant information to the loyalty account management system and vice versa. This enables a transaction system to interact with the payment processing system largely in accordance with normal operating protocols with the payment processing system operating to route information to the loyalty provider processing system as required.

In the event that the user interaction is a transaction request, the interaction message typically is a transaction request message indicative of a transaction amount and the request indication is a transaction request indication indicative of the transaction amount.

If the user interaction is a transaction confirmation, the interaction message is a transaction confirmation message indicative of a redemption amount and the request indication is a redemption request indication indicative of the transaction amount. However, the transaction confirmation message can also be indicative of a required funds amount, for example if the number of points redeemed does not cover the total transaction cost, in which case the payment system can be responsive to the transaction confirmation message cause a payment to be performed in accordance with the required funds amount.

To achieve this, in one example, when the transaction system displays an indication of the points amount, the transaction system can determine a points redemption amount in accordance with user input amounts and then cause the transaction to be performed in accordance with the points redemption amount. This for example, a user may select to redeem all the points specified so that the transaction is performed solely on the basis of points. However this is not essential and alternatively the user can decide to partially pay for the transaction using points paying for the remainder of the transaction balance using funds, for example from a user account.

It will be appreciated from the above that an aspect of the disclosure can include a transaction system that generates an interaction message indicative of the merchant identifier and the user identifier, and provides the interaction message to a payment system, the payment system being responsive to the interaction message to cause a loyalty account management system to use the user identifier to obtain loyalty point data indicative of at least a points balance for each of multiple user loyalty accounts, the multiple user loyalty accounts being associated with a number of different loyalty programs, use the merchant identifier to determine a merchant loyalty program, the merchant loyalty program being a loyalty program for which the merchant can redeem loyalty points, calculate a points amount in accordance with the loyalty point data, the merchant loyalty program, and one or more rules, the one or more rules being at least partially indicative of conversion rates between loyalty programs, receives a points message indicative of the points amount from the payment system, and displays an indication of the points amount.

Similarly, another aspect of the disclosure can include a system for managing multiple loyalty accounts, the system including a transaction system, a payment system, and a loyalty account management system, wherein, in use the transaction system generates an interaction message indicative of the merchant identifier and the user identifier, and provides the interaction message to a payment system, the payment system receives the interaction message, generates a request using the interaction message, the request being indicative of the merchant identifier and the user identifier, and provides the request to the loyalty account management system, and the loyalty account management system receives the request, uses the user identifier to obtain loyalty point data indicative of at least a points balance for each of multiple user loyalty accounts, the multiple user loyalty accounts being associated with a number of different loyalty programs, uses the merchant identifier to determine a merchant loyalty program, the merchant loyalty program being a loyalty program for which the merchant can redeem loyalty points, calculates a points amount in accordance with: the loyalty point data, the merchant loyalty program, and one or more rules, the one or more rules being at least partially indicative of conversion rates between loyalty programs, and at least one of provides a points indication indicative of the points amount to thereby allow the points amount to be presented to the user enabling the user to selectively perform a transaction at least partially in accordance with the points amount, and causes points to be redeemed at least partially in accordance with the points amount to thereby allow a transaction to be selectively performed.

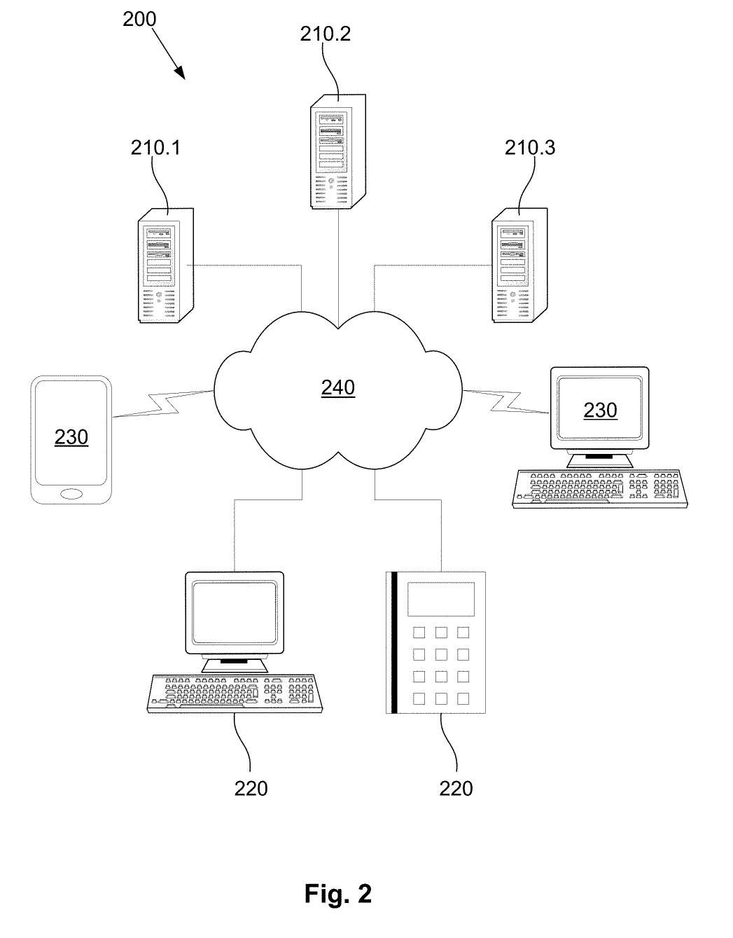

In one example, the process is performed by one or more processing systems operating as part of a distributed architecture 200, an example of which will now be described with reference to FIG. 2.

In this example, a number of processing systems 210 are provided coupled to one or more transaction systems 220, and one or more client devices 230, via one or more communications networks 240, such as the Internet, and/or a number of local area networks (LANs).

The processing systems 210 are typically operated by parties, such as acquirers, payment network service providers, issuers, loyalty account management service providers or loyalty providers. It will be appreciated that any number of processing systems 210, transaction systems 220, and client devices 230 could be provided, and the current representation is for the purpose of illustration only. The configuration of the networks 240 is also for the purpose of example only, and in practice the processing systems 210, transaction systems 220, and client devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing systems 210 are adapted to perform various data processing tasks forming part of a transaction and loyalty program management processes and the particular functionality will vary depending on the particular requirements. Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

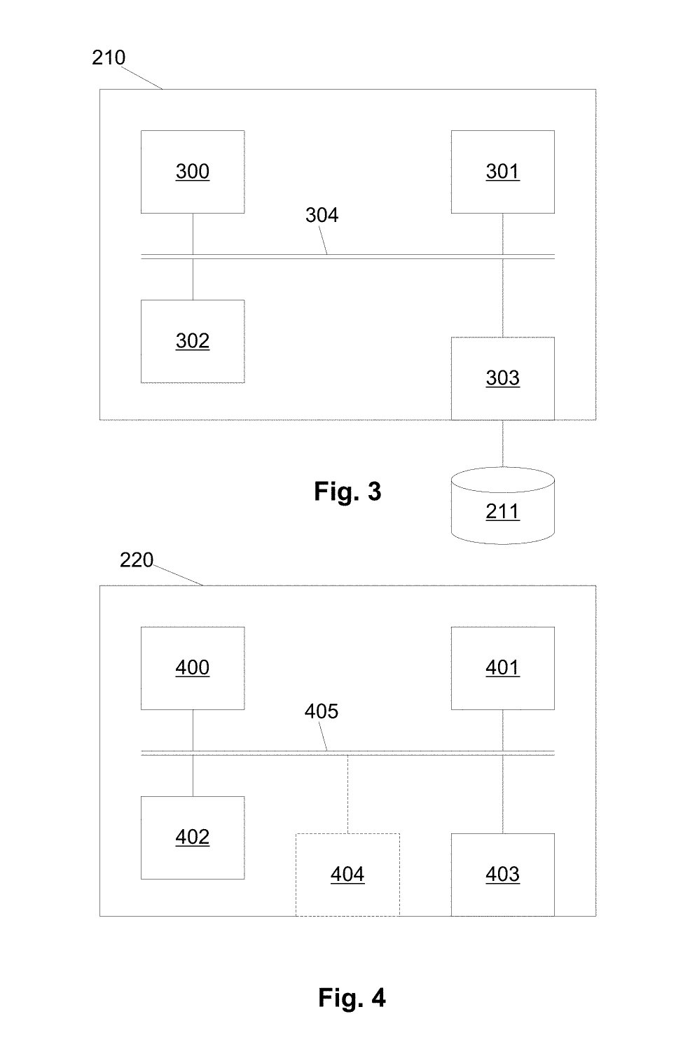

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example, the external interface 303 can be utilized for connecting the processing system 210 to peripheral devices, such as the communications networks 240, databases 211, other storage devices, or the like. Although a single external interface 303 is shown, this is for the purpose of example only, and in practice multiple interfaces using various methods (eg. Ethernet, serial, USB, wireless, or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed transaction terminal, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the transaction system 220 includes at least one microprocessor 400, a memory 401, an input/output device 402, such as a keyboard and/or display, an external interface 403, and an optional card reader 404, interconnected via a bus 405 as shown. In this example the external interface 403 can be utilized for connecting the transaction system 220 to peripheral devices, such as the communications networks 240 databases, other storage devices, or the like. Although a single external interface 403 is shown, this is for the purpose of example only, and in practice multiple interfaces using various methods (e.g. Ethernet, serial, USB, wireless, or the like) may be provided. The card reader 404 can be of any suitable form and could include a magnetic card reader, or contactless reader for reading smartcards, or the like.

In use, the microprocessor 400 executes instructions in the form of applications software stored in the memory 401, and to allow communication with one of the processing systems 210.

Accordingly, it will be appreciated that the transaction system 220 may be formed from any suitable transaction terminal, and could include suitably programmed PCs, web server, Internet terminal, lap-top, or hand-held PC, POS terminals, ATMs or the like, as well as a tablet, or smart phone, with integrated or connected card reading capabilities. However, it will also be understood that the transaction system 220 can be any electronic processing device such as a microprocessor, microchip processor, logic gate configuration, firmware optionally associated with implementing logic such as an FPGA (Field Programmable Gate Array), or any other electronic device, system or arrangement.

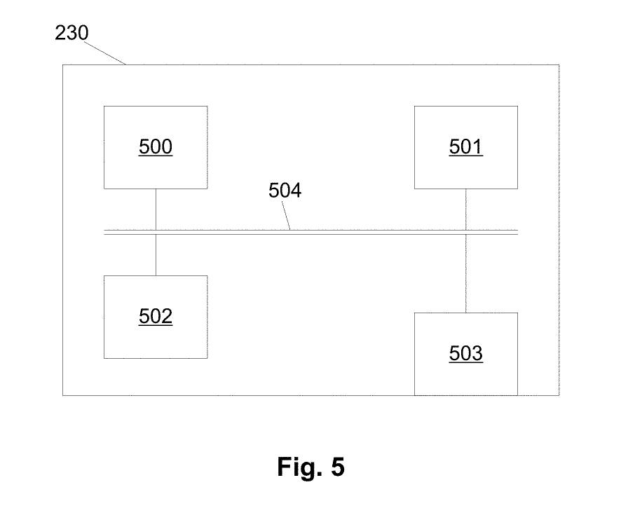

As shown in FIG. 5, in one example, the client device 230 includes at least one microprocessor 500, a memory 501, an input/output device 502, such as a keyboard and/or display, and an external interface 503, interconnected via a bus 504 as shown. In this example the external interface 503 can be utilized for connecting the client device 230 to peripheral devices, such as the communications networks 240 databases, other storage devices, or the like. Although a single external interface 503 is shown, this is for the purpose of example only, and in practice multiple interfaces using various methods (eg. Ethernet, serial, USB, wireless or the like) may be provided.

In use, the microprocessor 500 executes instructions in the form of applications software stored in the memory 501, and to allow communication with one of the processing systems 210.

Accordingly, it will be appreciated that the client device 230 be formed from any suitably programmed processing system and could include suitably programmed PCs, Internet terminal, lap-top, or hand-held PC, a tablet, a smart phone, or the like. However, it will also be understood that the client device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for managing loyalty accounts will now be described in further detail. For the purpose of these examples it is assumed that one or more respective processing systems 210 are servers that provide functionality required of a payment network, loyalty provider, and loyalty account manager. For ease of explanation, the servers will be described with reference to their respective functionality, including a payment network server 210.1, a loyalty account management server 210.2, and a loyalty provider server 210.3. The servers 210 typically execute processing device software, allowing relevant actions to be performed, with actions performed by the server 210 being performed by the processor 300 in accordance with instructions stored as applications software in the memory 301 and/or input commands received from a user via the I/O device 302.

It will also be assumed that actions performed by the transaction system 220, are performed by the processor 400 in accordance with instructions stored as applications software in the memory 401 and/or input commands received from a user via the I/O device 402, whilst actions performed by the client device 230 are performed by the processor 510 in accordance with instructions stored as applications software in the memory 501 and/or input commands received from a user via the user controls 514.

However, it will be appreciated that the above described configuration assumed for the purpose of the following examples is not essential, and numerous other configurations may be used. It will also be appreciated that the partitioning of functionality between the different processing systems may vary, depending on the particular implementation.

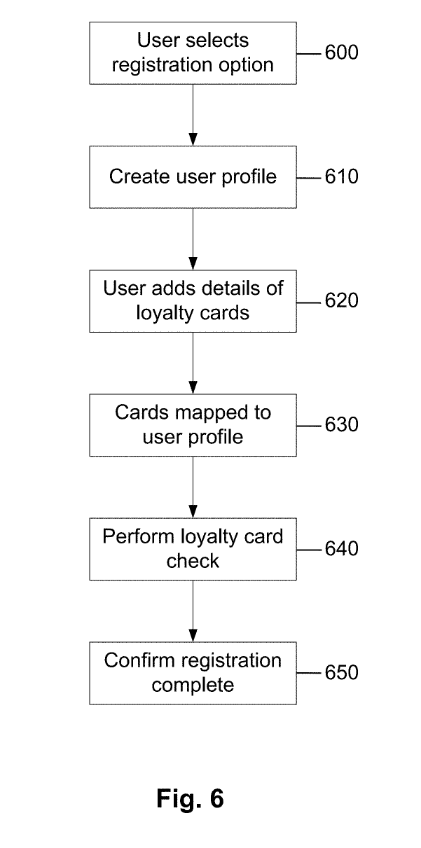

A specific example of a registration process will now be described with reference to FIG. 6. For the purpose of this example it is assumed that the user is utilizing a client device 230 in order to access loyalty account management services offered by the loyalty account management server 210.2. Such interaction could be achieved utilizing an application, such as mobile wallet application executed by the client device 230, or via a webpage based interface, or the like. Interaction may occur directly between the client device 230 and the loyalty account management server 210.2, or may be routed via a payment network server 210.1, depending on the preferred implementation.

In this example, at step 600 the user selects a registration option with this causing the loyalty account management server 210.2 to create a user profile at step 610. The user profile will typically be created by populating this utilizing previously provided customer information, for example by retrieving this from the mobile wallet application, or from a payment network server 210.1, or alternatively could be achieved by having the user manually enter the required information by displaying appropriate prompts to the user.

Having created a user profile at step 610, the user is prompted to provide details of their loyalty cards which are then entered at step 620. This can be achieved in any appropriate manner and can involve having the user manually enter details, such as a card name and number, or alternatively could be achieved by having the user capture an image of the card utilizing the client device 230.

Details of the loyalty cards are provided to the loyalty account management server 210.2, which adds the loyalty cards to the user profile at step 630. As part of this process, at step 640 the loyalty account management server 210.2 will typically operate to perform a loyalty card check, in particular confirming that the loyalty cards are valid and owned by the respective user. This check is typically performed by querying a loyalty provider server 210.3 operated by the loyalty provider administering the respective loyalty program. Thus it will be appreciated that if multiple loyalty cards are registered this process will typically involve querying a corresponding number of loyalty provider servers 210.3.

Once all the loyalty cards have been checked the loyalty account management server 210.2 can confirm registration is completed at step 650, for example providing a suitable notification to the client 230, allowing the user to then make use of the managed loyalty accounts.

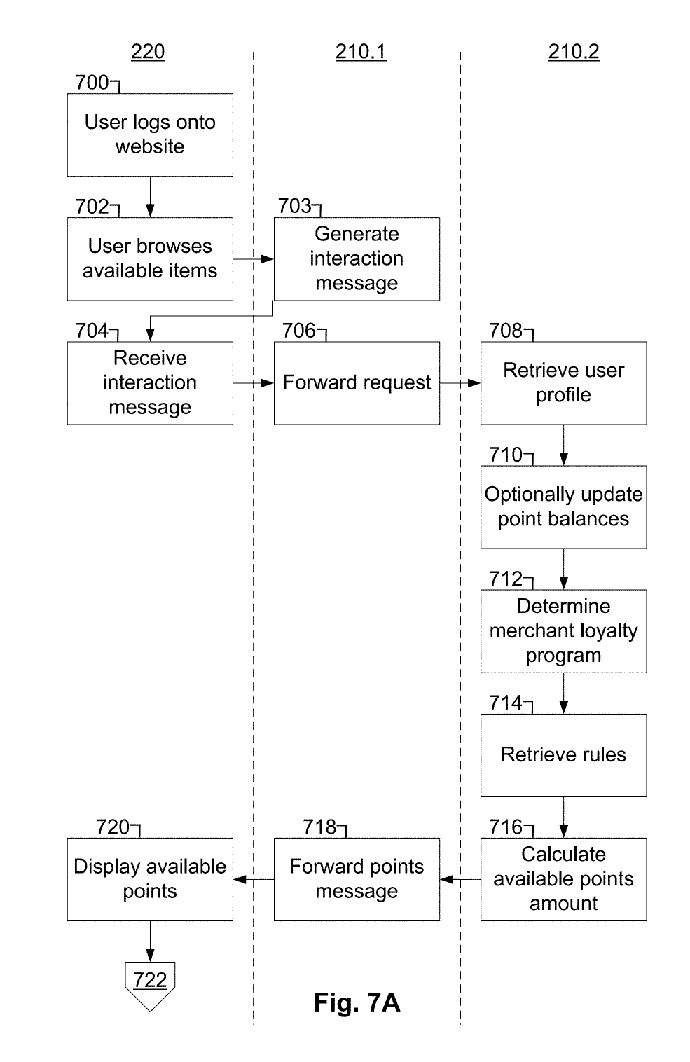

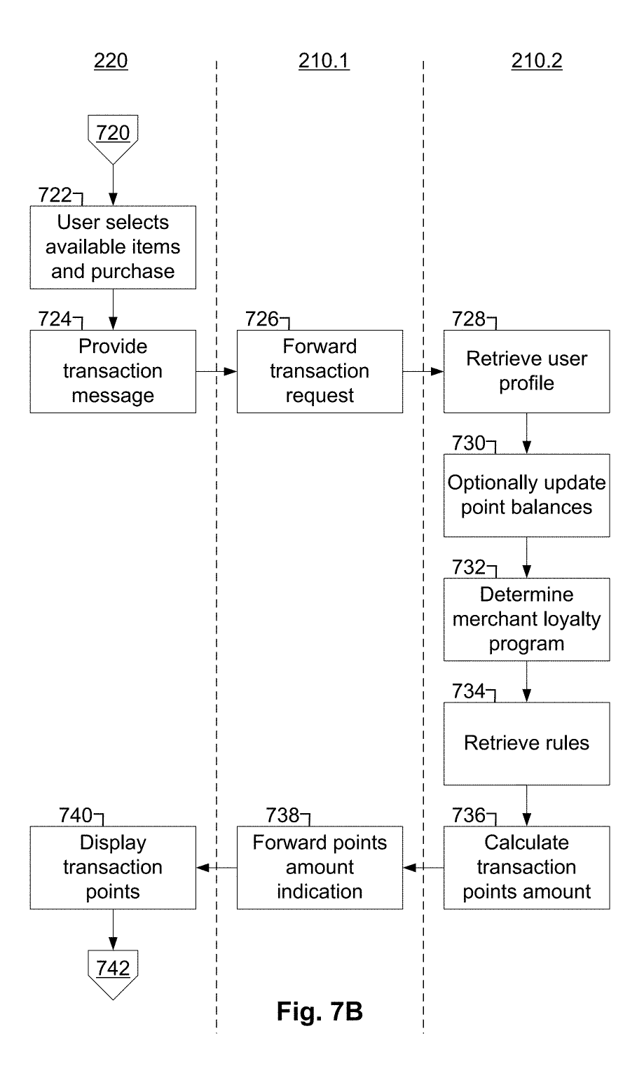

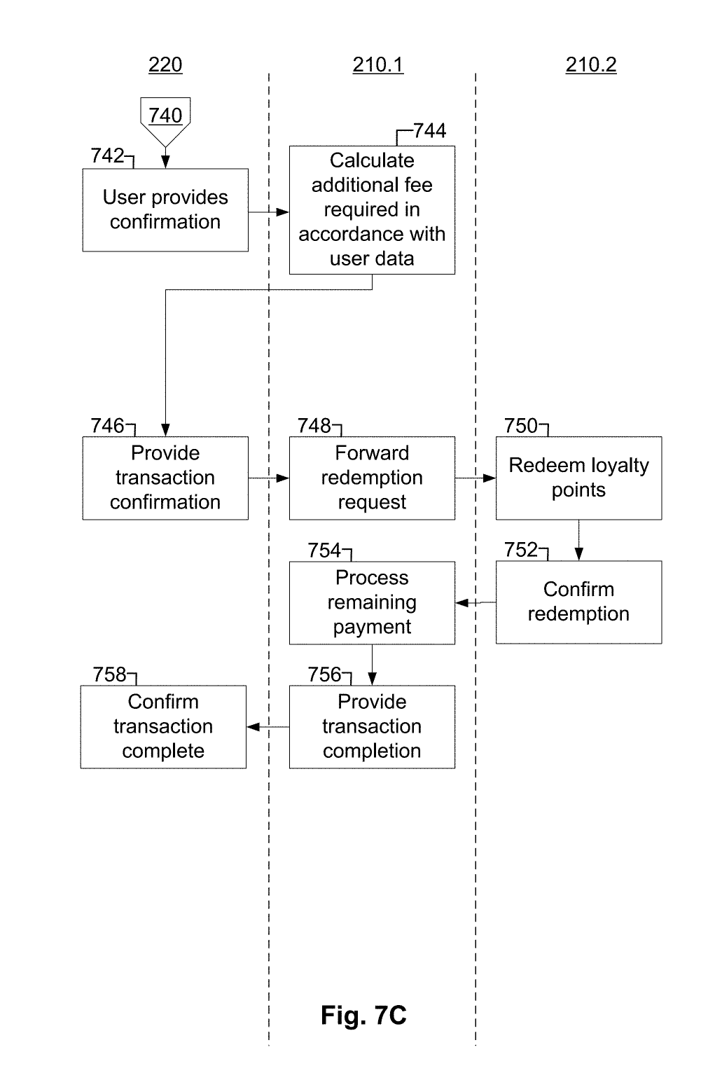

An example of the process for performing the transaction using the managed loyalty accounts will now be described with reference to FIGS. 7A to 7C.

For the purpose of this example, it is assumed that the user is performing a purchase via a merchant website, such that the transaction system 220 includes a website hosted by a respective server, with content of the website being viewed by the user using a client device 230. However, it will also be appreciated that this is not essential and some of the processes could be performed if the user is performing a transaction via a POS terminal or the like. Reference is also made to the payment network server 210.1 and the loyalty account management server 210.2, with functionality of the devices being shown in the respective columns in the flow chart.

In this example, at step 700 the user logs on to the website. It will be appreciated that the process of logging on typically involves having the user provide authentication information which is then used by the transaction system 220 to authenticate the user's identity. This process is performed in order to allow available points information to be returned while the user is browsing through available items at step 702. The interaction message is then generated at the payment network server 210.1 at step 703.

At step 704 the transaction system 220 receives, from the payment network server 210.1, an interaction message indicative of a user interaction in the form of a browsing interaction, with the interaction message including a merchant identifier, such as a merchant name or unique identification number, and a user identifier, such as a name or account number, retrieved from registration details when the user logs into the website at step 700. The payment network server 210.1 then forwards a request, including the merchant and user identifiers, to the loyalty account management server 210.2 at step 706.

The loyalty account management server 210.2 retrieves a user profile using the user identifier at step 708, and may be updates a point balance at step 710. In particular, if point balances are only updated as needed and it has been some time since the user's profile was previously accessed, point balances might be out of date in which case these may need to be updated by querying loyalty provider servers 210.3 for each of the user loyalty accounts.

Once account balances are up to date, at step 712 the loyalty account management server 210.2 determines the relevant merchant loyalty program using the merchant identifier, and then retrieves rules at step 714. The rules are used by the loyalty account management server 210.2 to calculate an available points amount at step 716, and in particular an available points amount which maximizes the monetary benefit to the user.

Specifically, the process uses business rules dynamically for calculating loyalty points in such a way that user gets maximum monetary benefits along with the least hassle and best experience while purchasing products/services. The business rules are applied contextually, for the current merchant loyalty program so that loyalty points expiring earliest gets precedence, higher conversion rates between loyalty programs gets precedence, less frequently redeemed loyalty programs gets precedence and loyalty programs preferred by a user get precedence.

Having calculated the available points amounts, a point amount indication is provided to the payment network server 210.1, which in turn forwards this to the transaction system 220 at step 718, allowing this to be displayed by to the user via the client device 230 at step 720.

At step 722, the user selects one or more available items for purchase and then typically selects a checkout procedure. As part of this process the transaction system 220 will generate a transaction message including the merchant identifier, user identifier and indication of a transaction amount, with this being provided to the payment network server 210.1 at step 724. This can be part of a normal transaction process, and could include providing a pre-authorization request to an acquirer switch, which passes this on the payment network server 210.1. The payment network server 210.1 then provides a transaction request to the loyalty account management server 210.2 at step 726.

At steps 728 to 736 the loyalty account management server 210.2 uses the transaction indication to retrieve the user profile, may be update point balances, select merchant loyalty programs and retrieve relevant rules allowing a transaction points amount to be calculated. It will be appreciated that this is broadly similar to the process performed with respect to steps 708 to 716, but in this case takes into account the transaction amount when determining the points amount.

Following this a points amount indication is provided to the payment network server 210.1, which forwards this a points message to the transaction system 220 at step 738, allowing the transaction system 220 to display an indication of the points required to perform the transaction at step 740. This can include an indication of a total number of points, as well as a breakdown indicating the loyalty accounts from which the points are being redeemed.

At step 742, the user provides confirmation that the transaction is to proceed, may be manually adjusting the breakdown or the number of points to be used. For example, the user could select to only use some of the points, choosing to pay a balance using a payment. Thus, at step 744 the payment network server 210.1 determines any additional fee required in accordance with user data obtained from the payment network server 210.1, with this information together with any modifications to the breakdown being used to generate a transaction confirmation message at step 746.

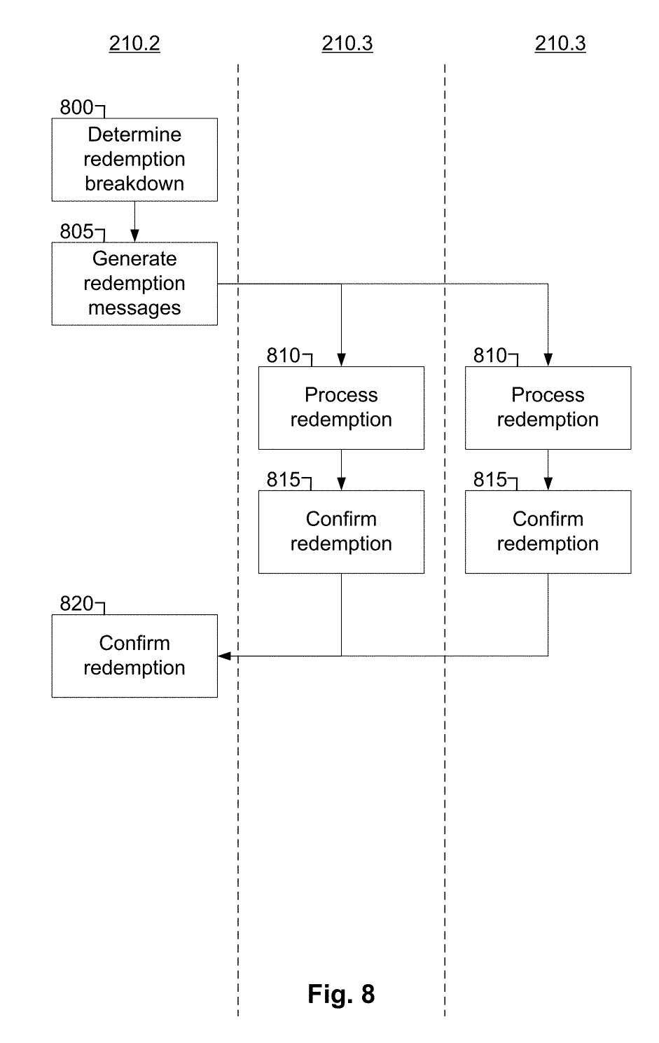

The transaction confirmation message is provided to the payment network server 210.1, again may be as part of a standard transaction process, with the payment network server 210.1 utilizing this to forward a redemption request, including the number of points to be redeemed and the breakdown, to the loyalty account management server 210.2 at step 748. The loyalty account management server 210.2 operates to redeem loyalty points as needed at step 750, performing this on the basis of the number of points specified in the breakdown as shown in FIG. 8.

In particular example, at step 800 the loyalty account management server 210.2 determines a redemption breakdown either from the redemption request, or based on the number of points selected by the user and the rules defining how points should be used. Redemption messages are then generated at step 805 with these being transferred to the loyalty provider server 210.3 for each of the different loyalty accounts from which points are redeemed.

Each loyalty provider server 210.3 will process the redemptions at steps 810 and provide redemption confirmations step 815. This is then used by the loyalty account management server 210.2 to confirm redemption at step 820.

Once confirmation of redemption is received from the loyalty provider server 210.3 at step 752 an indication of this is provided to the payment network server 210.1, which then processes any remaining payment at step 754. A transaction completion message is then generated at step 756 and provided to the transaction system 220, allowing this to confirm the transaction is complete at step 758.

Accordingly, the above described process provides a mechanism to allow multiple loyalty accounts, forming part of different loyalty programs, to be managed collectively.

In one example, this is achieved using a payment system backend, may be implementing this as an additional feature of the backend, allowing this to be seamlessly integrated into existing payment systems. This allows users to pay using multiple loyalty accounts when performing any transaction.

Specific examples will now be described to assist understanding of the end user experience.

### EXAMPLE 1

User has already enrolled for loyalty programs of Pluto Airlines.
User logs into Pluto Airlines site/app to buy/browse air ticket from NY to London.
User browses return ticket from 10 Sep. 2016 to 20 Sep. 2016.
Merchant sends information to loyalty account management system via payment network, including:
   User information
   Merchant Information
Loyalty account management system calculates the maximum monetary benefits out of available multiple loyalty programs for a user. Loyalty account management system uses following business rules to calculate maximum monetary benefits at run time. Loyalty account management system may give precedence to loyalty programs having:
   Loyalty points expiring earliest
   Higher conversion rates between loyalty programs
   Less frequently redeemed loyalty programs
   Preferred by user loyalty programs
Loyalty account management system sends maximum loyalty points that can be redeemed to Merchant
Merchant analyzes loyalty points and displays/highlights the flight which can be booked using provided loyalty points.
User goes ahead with booking one of the flights using payment network.
User logs into payment network.
Payment network forward the information to loyalty account management system.
Loyalty account management system calculates the maximum monetary benefits out of available multiple loyalty programs for a user. Loyalty account management system uses business rules as described above to calculate maximum monetary benefits.
Payment network asks for user's consent to redeem loyalty points.
If user gives consent, loyalty points are redeemed and balance amount can be paid by selected/default payment card for booking the ticket else regular payment network checkout experience.
If user doesn't have any loyalty programs enrolled into payment network, the booking experience will be as is.

### EXAMPLE 2

User has 1200 loyalty points from Emirates and has 1900 loyalty points from Singapore Airlines.
User signs up with loyalty account management system to get aggregator services for its airline loyalty
Loyalty account management system has agreements with Emirates and Singapore air
User has now balance of 3100 Loyalty points from Loyalty account management system
User needs to travel from Mumbai to Delhi for personal travel.
User checks online tickets on Emirates/Singapore Airlines and both of them has free tickets available for 2700 points.
User gets a real time notification that if they use the loyalty account management system they can get free tickets.
User immediately accepts and agrees to use the loyalty account management system for this transaction.
The loyalty account management system asks Emirates to go ahead with the booking.
Emirates confirms the booking marking it as a loyalty account management system transaction and charges the loyalty account management system 1700 points.
User gets confirmed ticket and he is able to fly free from Mumbai to Delhi.

The system uses business rules to dynamically calculate loyalty points in such a way that user gets maximum monetary benefits along with less hassle and better experience while purchasing product/service. Below are the business rules that can be used contextually,
Loyalty Points expiring earliest gets precedence
Higher conversion rates between loyalty programs gets precedence
Less frequently redeemed loyalty programs gets precedence
Preferred by user loyalty programs gets precedence

In one example, contextual notifications can be provided as soon as a user's identity is known, for example when the user logs in to a Merchant site/app. In this case, the merchant site/app sends a user identifier, merchant identifier, and may be an indication of merchant accepting loyalty programs to the loyalty account management system via the payment network. The loyalty account management system calculates maximum monetary benefits out of available loyalty points against business rules at run time and send notification to User via Merchant.

User can get geo location based notifications in such a way that user can avail maximum benefits out of available loyalty points. E.g., if user is nearby Walmart, MLS calculates maximum number of points from all loyalty programs of the user which can be redeemed at Walmart and notifies user about the same with push messages.

The system can provide a number of benefits. For example, for users they are more likely to use loyalty benefits and further obtain maximum returns of their acquired loyalty. For merchants, satisfied customers will make more purchase and hence more revenue opportunities for merchants involved. For issuers and acquirer, loyalty transactions will increase resulting in more revenue, whilst for service providers, they are now involved in an integral role in overall loyalty eco-system.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the disclosure broadly appearing before described.

1. A system for managing multiple loyalty accounts, the system including at least one processing device configured to:
a) receive a request indicative of:
i) a merchant identifier; and
ii) a user identifier;
b) use the user identifier to obtain loyalty point data indicative of at least a points balance for each of multiple user loyalty accounts, the multiple user loyalty accounts associated with a number of different loyalty programs;
c) use the merchant identifier to determine a merchant loyalty program, the merchant loyalty program being a loyalty program for which the merchant can redeem loyalty points;
d) calculate a points amount in accordance with:
i) the loyalty point data;
ii) the merchant loyalty program; and
iii) one or more rules, the one or more rules at least partially indicative of conversion rates between loyalty programs; and
e) at least one of:
i) provide a points indication indicative of the points amount to thereby allow the points amount to be presented to the user; and
ii) cause points to be redeemed at least partially in accordance with the points amount to thereby allow a transaction to be selectively performed.

2. A system according to claim 1, wherein the request is a balance request, and wherein the points amount is indicative of a total available points balance.

3. A system according to claim 1, wherein the request is a transaction request indicative of a transaction amount, and wherein the at least one processing device is configured to calculate the points amount at least in part using the transaction amount, the points amount indicative of a number of points required to complete a transaction for the transaction amount.

4. A system according to claim 1, wherein the request is a redemption request indicative of a redemption amount, and wherein the at least one processing device is configured to calculate the points amount at least in part using the redemption amount, the points amount indicative of a number of points to be redeemed.

5. A system according to any one of the claim 1, wherein the points amount is indicative of a points breakdown defining a number of loyalty points for each of a number of user loyalty accounts.

6. A system according claim 1, wherein the loyalty point data is indicative of at least one of:
a) a user assigned preference;
b) a loyalty point expiry date; and
c) a loyalty account usage.

7. A system according to claim 1, wherein the rules are defined so that the at least one processing device is configured to calculate the points amount so as to optimize a monetary benefit for the user.

8. A system according to claim 1, wherein the rules are defined so that the at least one processing device is configured to calculate the points amount taking into account:
a) a relative loyalty point expiry date for loyalty points of the user loyalty accounts;
b) a loyalty account usage; and
c) a user assigned preference.

9. A system according to claim 1, wherein the at least one processing device is configured to:
a) use the user identifier to access a user profile; and
b) determine, using the user profile, at least one of:
i) the loyalty point data; and
ii) rules.

10. A system according to claim 9, wherein the user profile includes a current points balance for each of a number of user loyalty accounts, and wherein the at least one, processing device is configured to update the current points balance at least one of:
a) periodically; and
b) in response to a loyalty account points balance notification from a loyalty provider processing system.

11. A system according to claim 9, wherein the at least one processing device is configured to:
a) identify one or more user loyalty accounts from the user profile;
b) query a loyalty provider processing system of each of the user loyalty accounts to determine a current points balance of each user loyalty account; and
c) determine the point data using the current points balance.

12. A system according to claim 1, wherein the at least one processing device is configured to cause loyalty points for a respective user loyalty account to be redeemed by:
a) generating a redemption instruction indicative of:
i) a redemption amount; and
ii) a recipient;
b) providing the redemption instruction to a loyalty provider processing system that manages the user loyalty account, the loyalty provider processing system responsive to the redemption instruction to redeem the points in accordance with:
i) the redemption amount; and
ii) the recipient.

13. A system according to claim 1, further including:
a) a transaction system;
b) a payment system; and
c) a loyalty account management system including the at least one processing device, wherein the loyalty account management system is configured to calculate the points amount and provide the points amount to the transaction system via the payment system, allowing the points amount to be displayed to at least one of a user and a merchant.

14. A system according to claim 13, wherein:
the loyalty account management system is configured to:
i) calculate a points amount; and
ii) provide the points indication to the payment system;
b) the payment system is configured to:
i) generate a points message indicative of the points amount;
ii) provide the points message to the transaction system; and
c) the transaction system is configured to:
i) receive the points message; and
ii) display an indication of the points amount.

15. A system according to claim 13, wherein, in response to user interaction with the merchant, the transaction system is configured to:
a) generate an interaction message indicative of at least:
i) the merchant identifier; and
ii) the user identifier; and
b) provide the interaction message to the payment system, the payment system responsive to the interaction message to provide the request indication to the loyalty account management system.

16. A system according to claim 15, wherein the user interaction is a transaction request and wherein:
a) the interaction message is a transaction request message indicative of a transaction amount; and
b) the request indication is a transaction request indication indicative of the transaction amount.

17. A system according to claim 15, wherein the user interaction is a transaction confirmation and wherein:
a) the interaction message is a transaction confirmation message indicative of a redemption amount; and
b) the request indication is a redemption request indication indicative of the transaction amount, wherein the transaction confirmation message indicative of a required funds amount, and the payment system responsive to the transaction confirmation message to cause a payment to be performed in accordance with the required funds amount.

18. A system according to claim 12, wherein the transaction system is configured to:
a) display an indication of the points amount;
b) determine a redemption amount in accordance with user input commands; and
c) cause the transaction to be performed in accordance with the redemption amount.

19. (canceled)

20. A method for managing multiple loyalty accounts, the method including, at least one processing device:
a) receiving a request indicative of:
i) a merchant identifier; and
ii) a user identifier;
b) using the user identifier to obtain loyalty point data indicative of at least a points balance for each of multiple user loyalty accounts, the multiple user loyalty accounts associated with a number of different loyalty programs;
c) using the merchant identifier to determine a merchant loyalty program, the merchant loyalty program being a loyalty program for which the merchant can redeem loyalty points;
d) calculating a points amount in accordance with:
i) the loyalty point data;
ii) the merchant loyalty program; and
iii) one or more rules, the one or more rules being at least partially indicative of conversion rates between loyalty programs; and
e) at least one of:
i) providing a points indication indicative of the points amount to thereby allow the points amount to be presented to the user, enabling the user to selectively perform a transaction at least partially in accordance with the points amount; and
ii) causing points to be redeemed at least partially in accordance with the points amount to thereby allow a transaction to be selectively performed.

21. A system for managing multiple loyalty accounts, the system including a transaction system configured to:
1) generate an interaction message indicative of:
i) the merchant identifier; and
ii) the user identifier;
b) provide the interaction message to a payment system, the payment system responsive to the interaction message to cause a loyalty account management system to:
i) use the user identifier to obtain loyalty point data indicative of at least a points balance for each of multiple user loyalty accounts, the multiple user loyalty accounts being associated with a number of different loyalty programs;
ii) use the merchant identifier to determine a merchant loyalty program, the merchant loyalty program being a loyalty program for which the merchant can redeem loyalty points;
iii) calculate a points amount in accordance with:
(1) the loyalty point data;
(2) the merchant loyalty program; and
(3) one or more rules, the one or more rules at least partially indicative of conversion rates between loyalty programs;
c) receive a points message indicative of the points amount from the payment system; and
d) display an indication of the points amount.

22. (canceled)
